(19) United States
(12) Patent Application Publication
(10) Pub. No.: US 2016/0349978 A1
(43) Pub. Date: Dec. 1, 2016

(54) KNOWLEDGE BASE STUDIO

(71) Applicant: AetherPal Inc., South Plainfield, NJ (US)

(72) Inventors: Deepak Gonsalves, Bridgewater, NJ (US); Ramesh Parmar, Scotch Plains, NJ (US); Pooja Chengappa, Bridgewater, NJ (US)

(73) Assignee: AetherPal Inc., South Plainfield, NJ (US)

(21) Appl. No.: 15/236,840

(22) Filed: Aug. 15, 2016

Related U.S. Application Data
(63) Continuation-in-part of application No. 14/095,135, filed on Dec. 3, 2013.
Application No. 14/095,135 is a continuation-in-part of application No. 14/075,377, filed on Nov. 8, 2013.
Application No. 14/075,377 is a continuation-in-part of application No. 15/193,641, filed on Jun. 27, 2016.
Application No. 15/193,641 is a continuation of application No. 14/042,846, filed on Oct. 1, 2013, now Pat. No. 9,378,030.
(60) Provisional application No. 62/205,328, filed on Aug. 14, 2015.
(60) Provisional application No. 61/733,125, filed on Dec. 4, 2012.
(60) Provisional application No. 61/725,747, filed on Nov. 13, 2012.

(51) Int. Cl. G06F 3/0484; H04L 29/06; G09B 5/06

(52) U.S. Cl. CPC G06F 3/04847; G09B 5/065; H04L 65/4015; H04L 65/1069

(57) ABSTRACT

Described herein is a method and system for a knowledge base studio that allows a designer to automatically create tutorials for connected devices with textual, visual and audio instructions by remotely connecting to a device over the air to view the device screen. It allows for publishing the tutorials to various platforms like customer agent desktops, websites, mobile apps etc. The knowledge base studio allows multiple designers to collaborate their work which can later be analyzed and approved by a moderator. The moderator can provide suggestions or reject tutorials that do not conform to the requirements. The knowledge base studio provides the ability to add scripts to tutorials to perform specific actions on the device and edit existing tutorials.

### CROSS REFERENCE TO RELATED APPLICATIONS

This application claims the benefit of U.S. provisional application No. 62/205,328, filed Aug. 14, 2015, which is incorporated by reference as if fully set forth and is a continuation-in-part of U.S. application Ser. No. 14/095,135, filed Dec. 3, 2013 titled “Knowledge Base in Virtual Mobile Management”, which claims the benefit of U.S. provisional application No. 61/733,125, filed Dec. 4, 2012; and U.S. application Ser. No. 14/075,377, filed Nov. 8, 2013 titled “Virtual Mobile Management for Device Simulation”, which claims the benefit of U.S. provisional application No. 61/725,747, filed Nov. 13, 2012; and U.S. application Ser. No. 15/193,641, filed Jun. 27, 2016 titled “Method and Apparatus for Interactive Mobile Device Guidance”, which is a continuation of U.S. application Ser. No. 14/042,846, filed Oct. 1, 2013, now U.S. Pat. No. 9,378,030, issued Jun. 28, 2016, all of which are incorporated by reference as if fully set forth

### TECHNICAL FIELD

This application is related to connected devices, systems, networks, care support systems, and associated methods of operation. The knowledge base studio is a tool that allows a designer to automatically create, edit and publish tutorials for connected devices with textual, visual and audio instructions by remotely connecting to a device over the air to view, capture and control the device screen.

### BACKGROUND

When an end user or subscriber calls in with an issue for a connected device, a remote support technician uses various cumbersome internal and external online resources in order to narrow down and troubleshoot the subscriber's issue. This exercise is usually time consuming given the variety and complexity of these devices, thereby, increasing the support call handling time and may frequently result in end user (customer) dissatisfaction. Unsatisfactory end user support calls usually result in repeat calls for the same issue thus increasing the overall cost of end user support. These trends have identified a need to create tutorials for various connected devices and make them available to various individuals including customer care agents, subscribers, device application developers and device testers.

### SUMMARY

Described herein is a knowledge base studio that allows a designer to automatically create tutorials for connected devices with textual, visual and audio instructions by remotely connecting to a device to view the device screen. The various modes of connecting to the device can include, but is not limited to, over the air connection, tethered connection or a networked connection. It also allows for publishing the tutorials to various platforms like customer agent desktops, websites, mobile apps etc. The studio allows multiple designers to collaborate their work which can later be analyzed and approved by a moderator. The moderator can provide suggestions or reject tutorials that do not conform to the requirements. The studio provides the ability to add scripts to tutorials to perform specific actions on the device and edit existing tutorials.

The method and system allows seamless creation and publication of tutorials for connected devices by remotely connecting to the device over the air to view, capture and control the connected device screen. The method and system allows creation of tutorials with textual, visual, audio and animated instructions supporting all device manufacturers, models and operating systems. The creation, management and use of interactive tutorials may be performed remotely using a remote management system.

### BRIEF DESCRIPTION OF THE DRAWINGS

A more detailed understanding may be had from the following description taken in conjunction with the accompanying drawings wherein are set forth, by way of illustration and example, certain embodiments. The drawings constitute a part of this specification and include embodiments and illustrate various objects and features thereof.

FIG. 1 shows an example system and architecture of a knowledge base system in accordance with some embodiments;

FIG. 2 shows an example control flow during an offline storyboard creation in accordance with some embodiments;

FIG. 3 shows example components of a storyboard content producer studio in accordance with some embodiments;

FIG. 4 shows an example control flow during an online storyboard creation in accordance with some embodiments;

FIG. 5 shows an example of the workspace namespace structure and availability;

FIG. 6 shows an example of the knowledge base studio menu along with the workspaces, namespaces and the tutorials created under them;

FIG. 7 shows an example of the knowledge base studio new article window where a designer can choose a device and initiate a remote connection with the device in order to create tutorials and related content on a connected device;

FIG. 8 shows an example of the knowledge base studio article creation window;

FIG. 9 shows an example of the knowledge base article approval window where a moderator can view and approve or reject an article created by a designer; and

FIG. 10 shows an example of the knowledge base article edit window where a designer can modify existing tutorials and other related articles.

### DETAILED DESCRIPTION

It is to be understood that the figures and descriptions of embodiments have been simplified to illustrate elements that are relevant for a clear understanding, while eliminating, for the purpose of clarity, many other elements. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein.

While detailed embodiments of the instant invention are disclosed herein, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the technology to variously employ the present invention in virtually any appropriately detailed structure.

Although features and elements are described above in particular combinations, each feature or element can be used alone without the other features and elements or in various combinations with or without other features and elements.

Described herein is a method and system that allows seamless creation and publication of tutorials for connected devices by remotely connecting to a device to view, capture and control the connected device screen. The method and system allows creation of tutorials with textual, visual, audio and animated instructions supporting all device manufacturers, models and operating systems. The creation, management and use of interactive tutorials may be performed remotely using a remote management system, such as for example, a virtual mobile management (VMM) system as described in U.S. application Ser. No. 14/095,135, filed Dec. 3, 2013 titled “Knowledge Base in Virtual Mobile Management”; U.S. application Ser. No. 14/075,377, filed Nov. 8, 2013 titled “Virtual Mobile Management for Device Simulation”; and U.S. application Ser. No. 15/193,641, filed Jun. 27, 2016 titled “Method and Apparatus for Interactive Mobile Device Guidance”, which is a continuation of U.S. application Ser. No. 14/042,846, filed Oct. 1, 2013, now U.S. Pat. No. 9,378,030, issued Jun. 28, 2016, which are incorporated by reference as if fully set forth.

The knowledge base studio system enables capture of device user interface screens remotely on a personal computer (PC), laptop, console or a tablet screen. Traditionally connected device tutorials were created mostly by using a camera or some kind of recording device to capture the device image. These images have to be then uploaded to a different system or software which can add animation and additional meta-information to the image. These images have to be then stitched together to create a meaningful tutorial. This is a very tedious and lengthy process especially when hundreds of tutorials have to be created for each device make, model and operating system. The knowledge base studio simplifies the entire process by providing a unified system that allows capturing images, adding animation, scripts and meta-information and then stitching them together to form a meaningful tutorial in a matter of minutes. This is a huge improvement compared to the traditional methods of creating tutorials for connected devices.

Multiple tutorials may be created, edited and published based on user rights. An administrator may create users and assign various roles or privileges to the user including as a designer, moderator and care agent. The administrator may also publish the tutorials to be used by care agents or end users. The designer may produce new tutorials, edit already produced tutorials and submit the tutorials to the moderators for approval. The moderator may approve, reject or propose changes to the tutorials. Approved tutorials may be published by the administrator.

An authorized user of the system may run tutorial usage reports. They can create detailed analytics on tutorial usage, popularity and accurateness. This allows network operators and organizations to understand customer behavior on connected devices, their preferences and pain points, allowing them to improve their service.

The tutorials may be created and used by content designers, device manufacturers, including original equipment manufacturers (OEMs), wireless service providers, application developers, customer care agents, software developers and testers.

The method and system eliminates the need for in-person access to the physical device. This enables more effective global collaboration for producing tutorials. Furthermore, this provides secure private remote access to develop tutorials for pre-market connected devices (devices that are not commercially available).

The tutorials may be published for use on customer care agent's desktops, mobile applications and websites. One of the major differentiators of this method is that all tutorial content needs to be created only once. It is automatically customized with different views that can be displayed depending on the needs of the end user.

The tutorials may be integrated with a remote troubleshooting system, thereby enabling customer care technicians to access the tutorials during a remote management session with a subscriber's device. The instant access to context sensitive tutorial allows faster issue resolution.

Integrated access to a remote device bank allows customer care technicians to mimic the subscriber's device environment and implement proposed solutions on the remote device bank's device prior to implementing it on the subscriber's device. The remote device bank is typically owned and operated by organizations for use by its employees and authorized agents. For example, this is shown in U.S. application Ser. No. 14/075,377, filed Nov. 8, 2013 titled “Virtual mobile management for device simulation”, which is incorporated by reference as if fully set forth.

The system allows viewing of these tutorials during a live remote control session. In particular, the system determines the contextual position of the customer care or remote support technician within the device that is being remotely managed or the application that is being accessed, and displays the relevant or applicable tutorials automatically. For example, this is shown in FIG. 11 of U.S. application Ser. No. 14/095,135, filed Dec. 3, 2013 titled “Knowledge Base in Virtual Mobile Management”, which is incorporated by reference as if fully set forth.

The system provides a simple and easy solution to create interactive tutorials for connected devices. This involves using the remote management system to remotely connect to a device and perform use case actions on the connected device. A video of all actions performed on the connected device is saved by the remote management system. This video can be retrieved from the server and input into the knowledge base studio, which allows the creation of tutorials and publication of the tutorials to the server in real time. The system automatically retrieves the correct tutorials to display to the user based on which application or context the user is on the device. The tutorials created may be interactive guidance tutorials with audio instructions as described in U.S. application Ser. No. 15/193,641, filed Jun. 27, 2016 titled “Method and Apparatus for Interactive Mobile Device Guidance”, which is a continuation of U.S. application Ser. No. 14/042,846, filed Oct. 1, 2013, now U.S. Pat. No. 9,378,030, issued Jun. 28, 2016, which is incorporated by reference as if fully set forth.

The system provides a method for creating tutorials during a live remote control session by picking and choosing segments of the incoming device stream, and eliminating the need to use pre-recorded videos or images of the connected device. For example, this is shown in FIG. 11 of U.S. application Ser. No. 14/095,135, filed Dec. 3, 2013 titled “Knowledge Base in Virtual Mobile Management”, which is incorporated by reference as if fully set forth.

The system also provides access to numerous connected devices in a device bank and allows remote interaction and control of aspects of the connected devices using a remote management system. This involves configuring of one or more connected devices in the device bank to mimic an end user's connected device configuration and environment in order to resolve an issue with the user's connected device. In other embodiments, the connected devices in the device bank can be used by developers to test and diagnose new applications and by customer representatives to train themselves on connected devices. The system and method provides an improved method for recreating the entire troubleshooting session that includes the key taps or key press events and screen displays from the connected devices of the device bank.

Another advantage of the system is the ability to add animation to the captured device screens while in remote connection with the device. A designer creating tutorials would be able to pick and choose the kind of animation that needs to be overlaid on the device image. Designers can choose to add a box or a circle around the area that needs to be highlighted by picking the correct tool from the studio and drawing the box or circle on the device image. Designers can also choose the gesture tool to represent the swipe and scroll actions on the device image.

Another advantage of the system is the ability to add textual instructions to the captured images. The designer can add textual instructions to each captured image. A text input box is presented to the designer after capturing each image of the tutorial.

Another advantage of the system is the ability to add audio instructions to the captured images. The knowledge base studio provides an audio recorder that allows the designer to record audio instructions while the tutorial is being created. The audio files can also be edited using the built-in audio editor.

In order to further simply the process of tutorial creation and reduce the effort required, the system also provides the ability to add multiple device hardware skins to a single captured image. This helps in reusing captured images for creating tutorials for multiple devices by just changing the skin of the image. This is especially helpful when numerous tutorials need to be created to devices which have the same user interface.

Another advantage of the system is ability to stitch the captured images together to form a meaningful device tutorial or guide. Once a designer captures the desired images to form a tutorial, the system automatically aligns it together as a step by step tutorial. For example, when a tutorial is created, each image picked by the designer is assembled together one after another along with its corresponding instruction as a step of the tutorial. The designer can rearrange the steps if necessary using the rearrange buttons. The designer can add additional instructions, delete and re-order instructions at any time.

Another advantage of the system is the ability to add hyperlinks to tutorial instructions. A designer can include links to internal knowledge base website and relevant external articles within the tutorials. This allows the customer care technician to have all the necessary information to troubleshoot customers device in a single portal.

Yet another advantage of the system is the ability to link related tutorials together. The designer can choose multiple tutorials and link them to the current tutorial instructions within the knowledge base studio

The knowledge base studio has the ability to automatically capture metadata and contextual information of the current application or function (i.e. the application or function that is executing on the device) such as for example the user interface layout of the view/page, properties of each user interface element, the relative positions of the user interface elements, and the relationships between the user interface elements, and the like. The user interface elements are for example various user interface controls on a given screen, such as a text field for user input, a combo box which allows a user to select multiple options, a text label that displays text for the user, and other like controls. This is especially useful when the tutorials are being viewed within the remote control system. The system can automatically highlight and bring to focus tutorials that customer support agents might need when the agent is remotely navigating through the customer device. This is also useful in cases where the tutorials are loaded onto the customer's device for reference. This allows a remote management system client, such as a VMM client, to track user actions on the device and intelligently display relevant tutorials when necessary without the user having to search for these tutorials. This also allows the system to track the user location on the device while using interaction navigational guides. Furthermore, this metadata is used in U.S. application Ser. No. 15/193,641, filed Jun. 27, 2016 titled “Method and Apparatus for Interactive Mobile Device Guidance”, which is a continuation of U.S. application Ser. No. 14/042,846, filed Oct. 1, 2013, now U.S. Pat. No. 9,378,030, issued Jun. 28, 2016.

Yet another advantage of the system is the ability to add decision flows into a tutorial that allows the system to intelligently customize tutorial instructions to a user's device. An example of this scenario is when a customer's device has multiple browser applications each having different user interfaces and different application settings. A designer can embed decision flows within tutorials to detect the browser application used by a customer and correctly display relevant instructions when the customer needs assistance.

Yet another advantage of the knowledge base studio is the ability to embed scripts into tutorials that allow a remote control client to automatically perform specific actions on the connected device while using the tutorial. The ability to embed scripts within a tutorial allows a designer to create a power tutorial which not only provides audio and visual instructions to a customer but also performs the actions specified in the tutorial instructions.

Yet another advantage of the knowledge base studio is the ability to edit tutorials after creation. The studio provides the ability to edit textual instructions, delete instructions and also realign instructions as desired. Yet another advantage of the knowledge base studio is the ability to add additional images to the tutorials after creation which is made possible by actually recording a video of the entire remote control session during creation of the tutorial. In order to create a tutorial, a designer initiates a remote control connection with the connected device. While the tutorial is being created by a designer, the entire remote control session with the connected device is recorded by the studio. This allows the designer to edit tutorial images in future and add additional images into the tutorial by picking new images from the remote control session video.

Yet another advantage of the studio is its ability to automatically captures device properties and tie it to the tutorials. This allows the system to automatically categorize and index the tutorials and to facilitate a faster search.

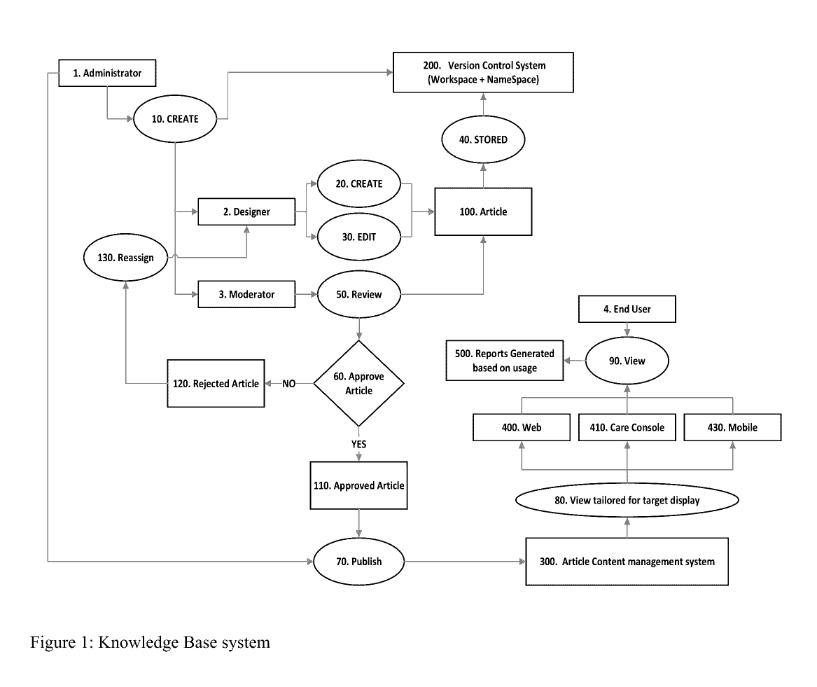

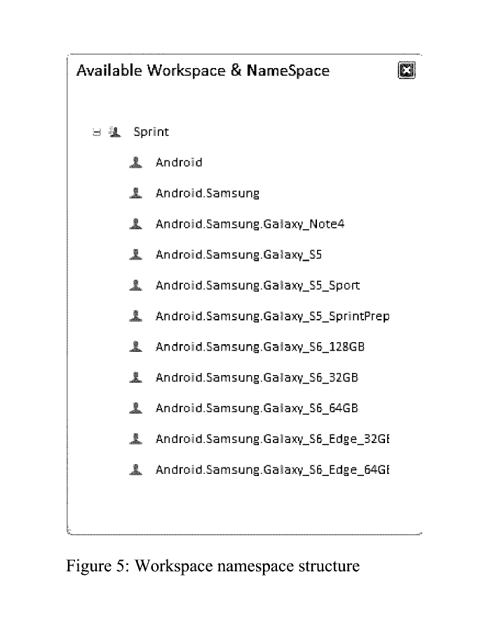

FIG. 1 shows the overall knowledge base system and the interaction between its different components of the system. The system involves 4 major actors. The Administrator [1], Designer [2], Moderator [3] and the End user [4]. Each of these actors are users of the system who are assigned specific privileges and play different roles in the system. A user with administrative privileges has the ability to create new users with designer and moderator privileges [10]. The administrator [1] also creates the workspaces and namespace structure which constitutes the version control system [200]. The workspace namespace structure is described in detail in FIG. 5. The term articles, storyboards and tutorials are used interchangeably throughout this specification to refer to the guidance available for a specific issue.

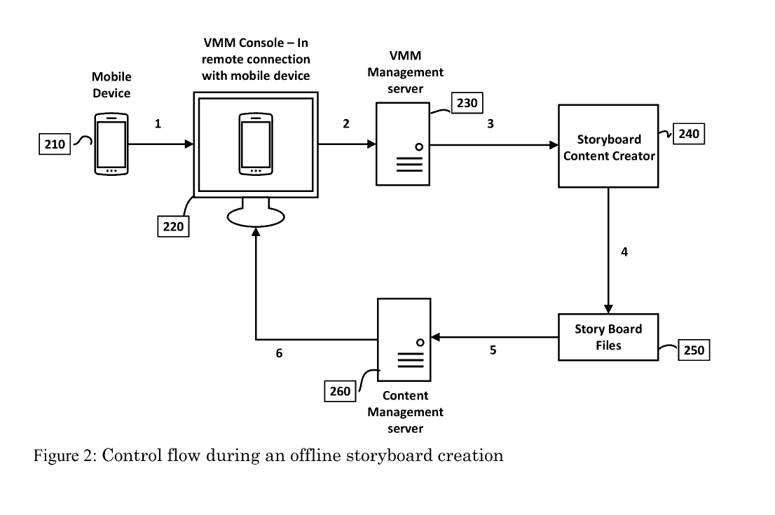

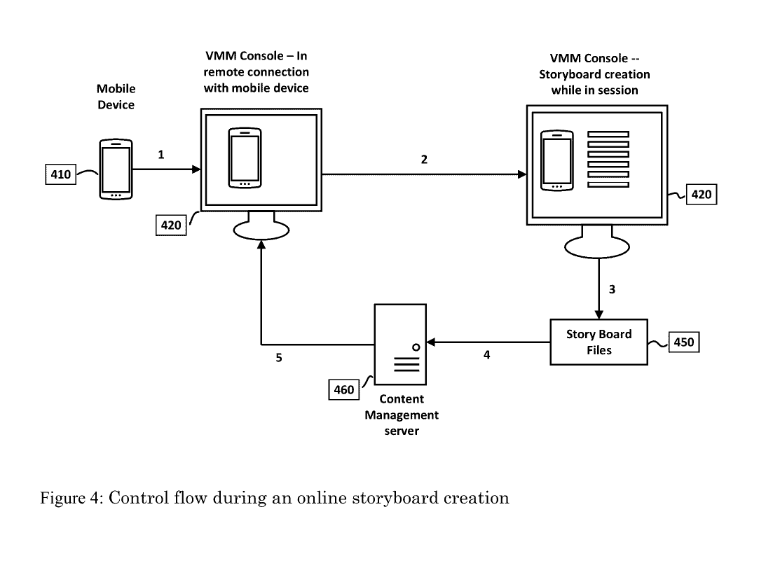

Each designer [2] is assigned a workspace and namespace and all articles [100] created by the designer [2] are stored in the respective workspace and namespace before it is published to a content management system [300]. A designer [2] has the responsibility of creating new articles [20] and editing existing ones [30] that need modifications. The designer [2] can create articles in online mode where a remote control session is established with the device prior to creating articles. This is described in detail is FIG. 2. The designer [2] can also create articles in offline mode where videos or previously recorded remote control sessions can be used for the purpose of creating articles. This is described in detail in FIG. 4. Once the knowledge base article is created, it is stored in the version control system [200] within the respective namespace and workspace [40].

The moderator [3] is a user with the responsibility of reviewing articles created by the designer [2] [50]. Once the article is created by a designer [2], it is sent to the moderator [3] for review who then approves or rejects the article based on its quality and accuracy [60]. If an article is rejected by the moderator [3], then the rejected article [120] is reassigned back to the designer [2] along with remarks and recommendations [130]. The designer [2] can edit the article [100] at any time and make corrections to it [30]. If an article [100] is approved by the moderator [3], then the approved article [110] is ready for publishing. All approved articles [100] will be published [70] into the content management system [300] by the administrator [1]. Once the articles are published, they are available for viewing in different portals. The same article content can be viewed on the web [400], remote technician console [410] or the mobile device [430]. The content management system [300] tailors the view to suit the target display [80]. The end user can view these articles on any portal [90]. All end user activity is monitored and recorded. Reports can be generated on tutorial access at any time [500].

Knowledge base articles [100] can be created in an online mode or an offline mode. In case of online mode, the designer [2] is in a remote control session with the mobile device on which the articles [100] are being created. The image stream from remote control session is used to create the articles [100]. In case of offline article creation, the designer [2] is not actively performing a remote control session with the mobile device. Instead a video of the device could be recorded prior to article creation and this video could be used for article creation.

FIG. 2 describes an example process for creating tutorials or storyboards in an offline mode. The components that interact with each other during the offline storyboard creation process includes a connected device 210, a remote management system console (e.g., VMM console) 220 which is used by the designer, a remote management system server (e.g., a VMM management server) 230, a storyboard content creator or producer 240 and a content management server 260. In order to create a new storyboard file 250, the designer would initiate a remote control session with the connected device 210 through the remote management system console 220. The remote management system console 220 receives screen capture images from the connected device 220 in real time [1]. The remote management system console 220 transfers these images into the remote management system management server 230, which stores them as a video file, for example, a binary file for future processing [2]. At this point the remote control or management session is terminated. The designer can retrieve these video files as needed and upload it to the storyboard content producer or creator studio 240 [3]. The storyboard content producer or creator 240 parses the video file and presents a video of all the operations performed on the connected device 210. The designer can use this video to choose required images or segments of the video and enter additional instructions and information to create a series of storyboard tags. The designer is also provided the ability to add additional animation and audio to the chosen images and videos. The storyboard tags also have associations to specific device make, model, software version and operating system version. The storyboard tags are then bundled together to create a storyboard file 250 [4]. These storyboard files 250 are published to the content management server 260 [5]. The content management server 260 is responsible for storing and managing all the storyboard files 250. They are also indexed and prioritized using various proprietary algorithms, so that they can be retrieved efficiently during remote control sessions. The storyboard files 250 can then be requested from the content management server 260 and viewed on the VMM console 220 by the remote support technician during a customer support call [6].

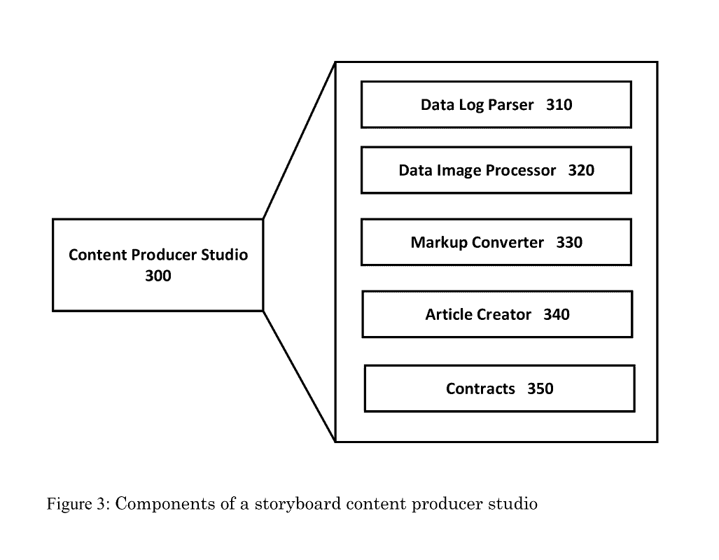

FIG. 3 displays example components of a storyboard content creator studio 300. The storyboard content creator studio 300 includes a data log parser 310, a data image processor 320, a markup converter 330, and an article creator 340, and a web service contracts 350. The data log parser 310 is responsible for receiving the video files, such as for example binary files, from a remote management system management server and parsing them to retrieve the images of the device screen. The data image processor 320 is responsible for processing the image files and adding the device hardware details to the image. The markup converter 330 is responsible for processing and managing any instructions that get added to the storyboard file. It also converts any text coming in as rich text format (RTF) to hypertext markup language (HTML) and HTML to RTF. The article creator 340 is responsible for creating storyboard tags by adding animation, audio and instructions to the device screen images. The multiple storyboard tags are combined together for a final storyboard article. The web service contracts 350 is responsible for managing the communication between the content creator studio 300 and a content management server. It is responsible for publishing storyboard articles to the content management server and receiving created storyboard files for editing.

FIG. 4 describes an example process for creating storyboards in an online mode. The components that interact with each other during the online storyboard creation process comprises of a connected device 410, a remote management system console 420 which is used by the designer and a content management server 460. In order to create a new storyboard file 450, the designer initiates a remote control session with the connected device 410 through the remote management system console 420. Once the session is initiated, the connected device 410 transmits screen display images to a remote management server, such as a remote management system server, which can be viewed on the remote management system console 420 [1]. The designer is also provided with the ability to pick images and segments of the device screen display and add instructions, animation and audio to it on the remote management system console 420 [2]. The captured and processed images are then combined to form a storyboard file 450. Additional information is added to associate the storyboard files to the correct device make, model, software version, operating system version and other like information [3]. These storyboard files 450 are transferred to the content management server 460 [4]. The content management server 460 processes the storyboard files 450 to categorize and index them. The storyboards 450 can be viewed on the remote management system console 420 later for training and troubleshooting purposes [5].

FIG. 5 shows an example of the Workspace and name space structure. In order to allow for multiple designers to collaboratively work on the article creation process and to organize the created articles correctly, a workspace and namespace structure is defined for the knowledge base studio. The system also allows of creation of one or more workspaces with the following structure—Workspace1, Workspace2 and so on. Each workspace is a virtual container for the project. Each workspace can comprise of one or more layers known as namespaces. A namespace is a duplication of an object under revision control also known as the trunk, where trunk refers to the unnamed branch of a file tree under revision control. Multiple namespaces from multiple sources can all be contained inside a workspace, with the primary constraint being that each namespace name be unique. The system allows for creation of one or more namespaces with the following structure:—com, for example, com.android, and com.android.samsung. Namespaces provide a way of encapsulating articles and allow multiple articles to exist with the same name in different namespaces. A user with designer privileges is assigned to one or more workspaces and within each workspace, to one or more namespaces. All the articles created by a designer get added into one of these namespaces. Due to the structure of the workspaces and namespaces, multiple designers can work collaboratively on multiple articles within their respective namespaces without having any conflicts. Once the articles are created, the designer is given option to commit articles at which point the article is added to a main container trunk.

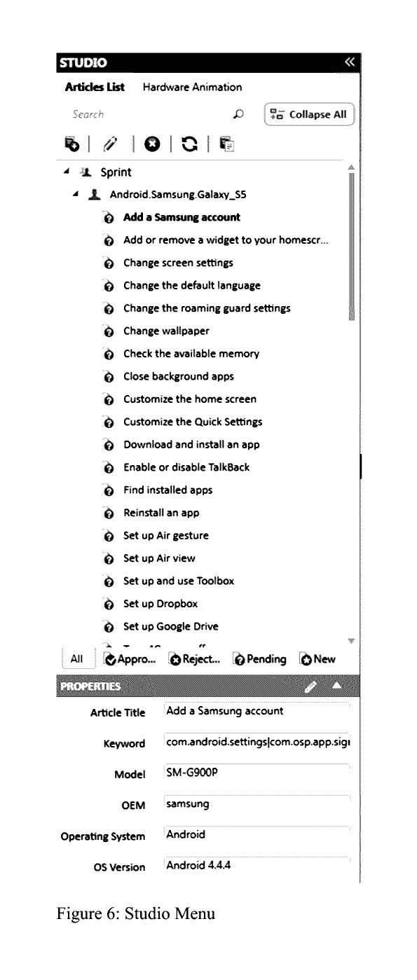

FIG. 6 shows an example of a knowledge base studio menu section. When a designer logs into the studio, the menu screen is displayed. All the workspaces and namespaces assigned to the designer are displayed along with all the articles previously created within the namespace. The designer has the option to create new articles, edit existing articles, delete existing articles, copy existing articles and paste copied articles. The designer can view the properties captured for each of the articles like the article title, keywords captured for each article, the model name, original equipment manufacturer name, operating system, operating system version and so on. Keywords refer to the metadata captured automatically for each article during the article creation process. This metadata contains information like applications opened, process and view names and the context in which the articles can be used. This allows the system to automatically categorize the articles and make them searchable by context.

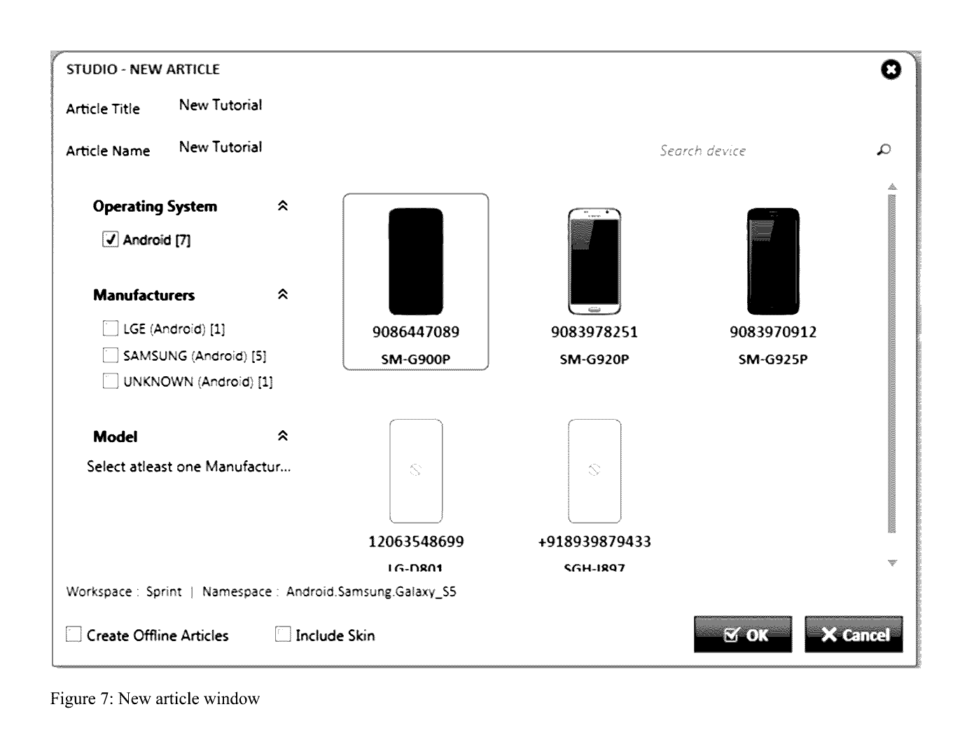

FIG. 7 shows the knowledge base studio and article window. In order to create a new tutorial or article, a designer first choses the appropriate namespace. The designer will then perform a remote control connection with a connected device pre-enrolled to the knowledge base system. The designer does not need to have a physical device in hand to create an article. On the new article window, the designer can specify Article title, Article name and also search for any pre-enrolled device. The pre-enrolled device can be searched by phone number, operating system, manufacturer name or model name. The designer can select the desired device and initiate a remote control session with the device.

The knowledge base studio also provides the ability to create offline articles. In case of offline articles, a designer does not need to remotely connect to any device in particular. A designer can create generic, non-device specific articles using this method. A designer is also provided with the option to include or exclude hardware skins while creating device related tutorials and articles. If a designer chooses to exclude hardware skins from tutorials, the tutorials are created by only capturing connected device user interface or screen. The hardware skin of the device is overlaid on the device screen at a later stage in the article creation process. A single tutorial can be associated with multiple hardware skins. This allows for reusing of common tutorials across multiple device models and operating system versions.

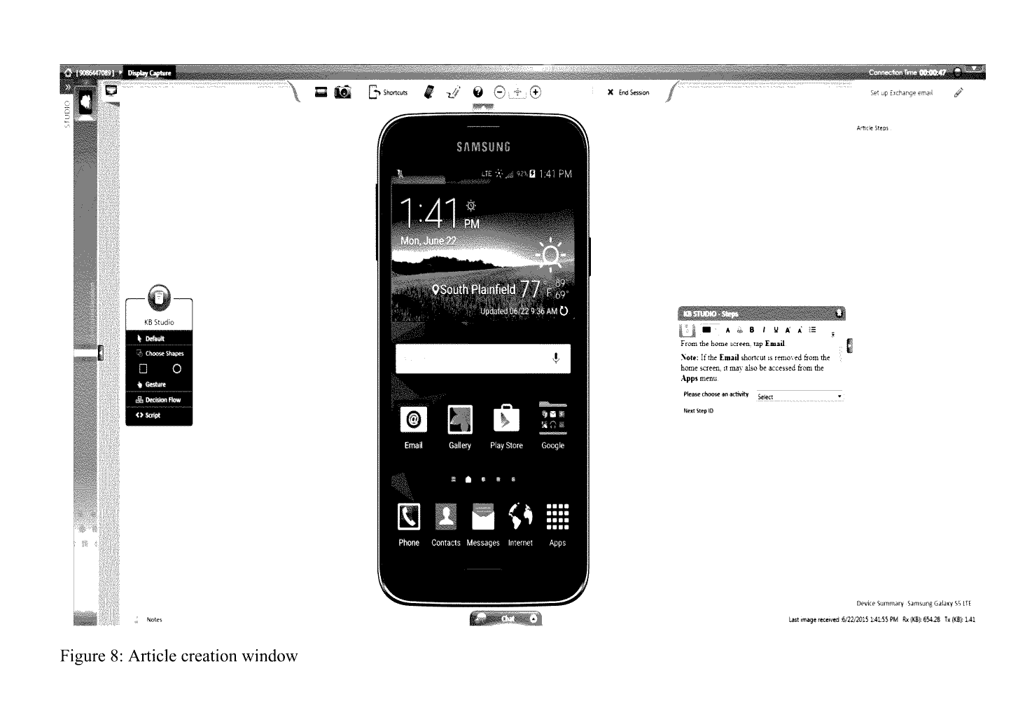

FIG. 8 shows an example of a knowledge base article creation window. Once a designer is remotely connected to the connected device, the article creation screen is displayed. On this screen, the designer can remotely view and navigate through the connected device user interface and choose device screen images that need to be picked to create a new tutorial. After choosing the necessary device screen image, the designer can add visual animation, textual instructions, audio instructions, decision flows and scripts to the image. A studio tool box is provided from which the designer can pick a variety of tools to add animation on the device screen. The default option allows the designer to navigate through the remote device. The shape options allow different shapes to be drawn on the device screen to highlight areas of the device screen that require user input. The gesture option allows the designer to add swipe and scroll animations to the chosen device screen. The decision flow tool allows a designer to add additional logic to the tutorial by providing the ability to specify conditions and policies that need to be meet for a tutorial step to be hidden or displayed. The scripting tool allows a designer to embed scripts within an article or tutorial which could perform a specific action or a combination of actions on a device when the tutorial is being viewed. In order to add animation on device image, a designer can choose the desired animation tool and draw on the device image. Once animation is added, the designer can add textual and audio instructions in the steps window. All steps added are displayed immediately for further modifications. Once a designer adds all the necessary steps for a given tutorial, it can be saved into the namespace.

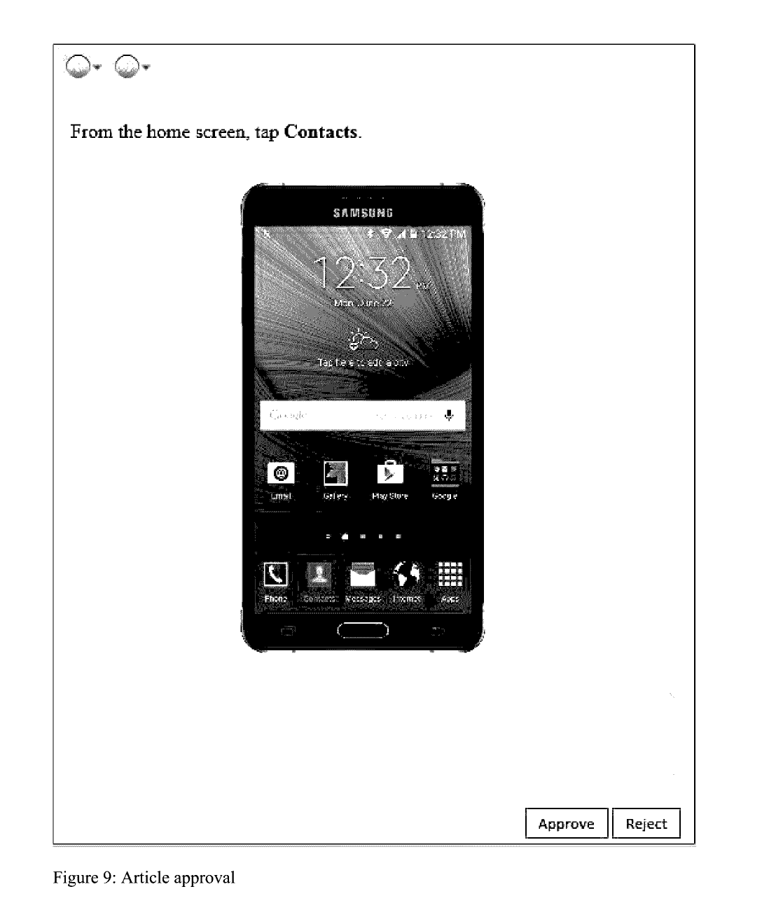

FIG. 9 shows an example of the article approval window. All articles and tutorials created by a designer can be reviewed at a later time by a user with approver privileges. The knowledge base system provides the ability to view all created articles in its finished form for the approval process. An approver can view all the images, instructions and animation added to article. If an article is created correctly, the approver can approve the articles. If an article requires modifications or additional details, the approver can reject the articles and provide additional information that can be later viewed by the designer.

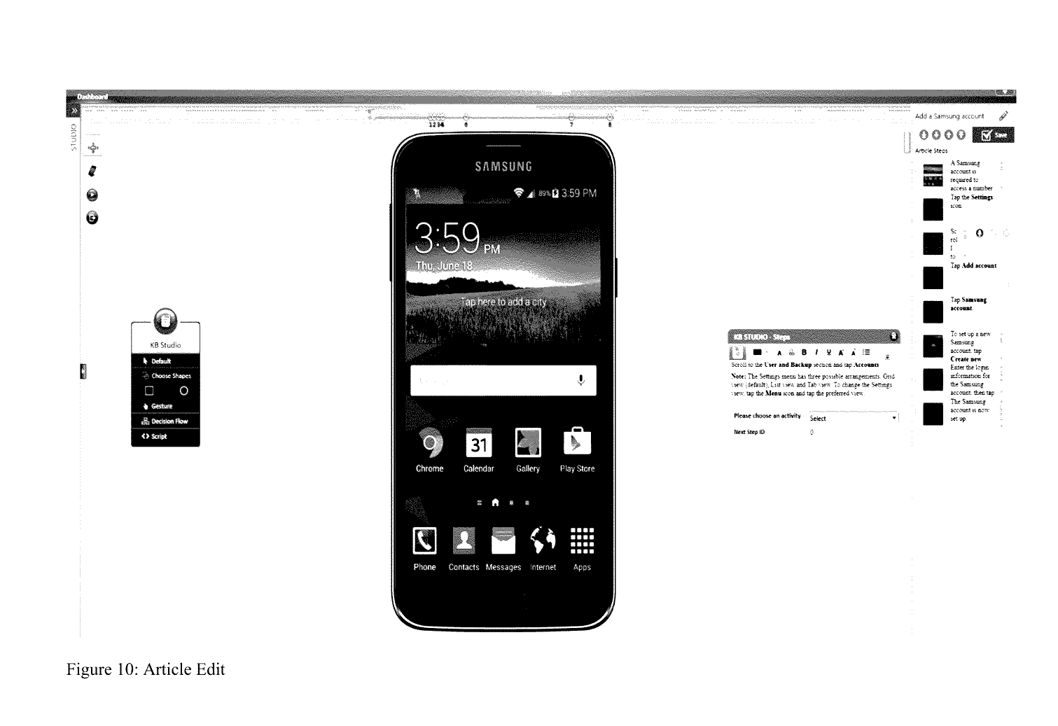

FIG. 10 shows an example of the article edit window. Existing articles can be edited by a designer using the edit functionality of the knowledge base studio. While editing an article, the knowledge base studio not only displays the individual steps of each article but also presents a designer with the entire video of the remote control session performed on the connected device. This allows a designer to not only edit existing steps and instructions but also to pick and choose additional images and add new steps to an article.

While detailed embodiments of the instant invention are disclosed herein, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the technology to variously employ the present invention in virtually any appropriately detailed structure.

Although features and elements are described above in particular combinations, each feature or element can be used alone without the other features and elements or in various combinations with or without other features and elements.

What is claimed is:

1. A method for tutorial processing, the method comprising:
establishing a remote management session between a console and a connected device;
capturing of connected device user interface screens remotely during the remote management session at the console;
adding textual, visual, audio, animation, scripts and meta-information to the captured connected device user interface screens to generate tutorials at the console;
submitting the tutorials for approval; and
publishing the tutorials across multiple user platforms.

2. The method of claim 1, wherein each tutorial is published with different views for each of the multiple user platforms.

3. The method of claim 1, wherein the tutorials are executable on a device in a remote device bank prior to implementing on a problem connected device.

4. The method of claim 1, wherein the tutorials are accessible during subsequent remote management sessions to assist in troubleshooting issues with a problem connected device.

5. The method of claim 1, further comprising:
determining a contextual position within a problem connected device; and
displaying each of the tutorials relevant to the determined contextual position.

6. The method of claim 1, further comprising:
capturing a video stream of all actions that occurred during the remote management session.

7. The method of claim 6, further comprising:
selecting segments from multiple video streams; and
automatically stitching together the segments for use in a tutorial.

8. The method of claim 1, wherein hyperlinks in the tutorials provide additional information to a user of a tutorial.

9. 7. The method of claim 6, further comprising:
linking together associated tutorials.

10. The method of claim 4, further comprising:
capturing associated metadata and contextual information; and
displaying each of the tutorials that are relevant as a user navigates through the user's connected device using the associated metadata and contextual information.

11. The method of claim 1, further comprising:
determining which platform of the multiple user platforms is being used; and
providing a view appropriate to the determined platform.

12. The method of claim 1, further comprising:
embedding scripts into the tutorials to automatically perform specific actions described in the tutorials.

13. The method of claim 1, wherein adding the textual, visual, audio, animation, scripts and meta-information to the captured connected device user interface screens is completed during the remote management session.

14. The method of claim 1, wherein adding the textual, visual, audio, animation, scripts and meta-information to the captured connected device user interface screens is completed after completion of the remote management session.

15. A system for storyboard processing, comprising:
a remote management console configured to establish a remote management session between the remote management console and a connected device;
a remote management server for storing captured connected device user interface screens and streaming video remotely during the remote management session;
a storyboard content producer/creator configured to add textual, visual, audio, animation, scripts and meta-information to the captured connected device user interface screens to generate storyboards based on input received from the remote management console;
the storyboard content producer/creator configured to submit the storyboards for approval based on input received from the remote management console; and
a content management server configured to publish approved storyboards across multiple user platforms.

16. The system of claim 15, wherein each tutorial is published with different views for each of the multiple user platforms.

17. The system of claim 15, wherein the storyboards are executable on a device in a remote device bank prior to implementing on a problem connected device.

18. The system of claim 15, wherein the storyboards are accessible during subsequent remote management sessions to assist in troubleshooting issues with a problem connected device.

19. The system of claim 15, wherein the content management server is configured to determine which platform of the multiple user platforms is being used and provides a view appropriate to the determined platform.

20. The system of claim 15, wherein the storyboard content producer/creator is configured to embed scripts into the storyboards to automatically perform specific actions described in the storyboards.
